(19) United States
(12) Patent Application Publication
(10) Pub. No.: US 2014/0101680 A1
(43) Pub. Date: Apr. 10, 2014

(54) VIEWING SYSTEM, MOBILE TERMINAL, SERVER, AND VIEWING METHOD

(71) Applicant: NEC CASIO MOBILE COMMUNICATIONS, LTD., Kawasaki-shi (JP)

(72) Inventor: Yosuke KANEKO, Kanagawa (JP)

(21) Appl. No.: 13/644,504

(22) Filed: Oct. 4, 2012

(51) Int. Cl. H04N 21/4788; H04N 21/439; H04N 21/233

(52) U.S. Cl. CPC H04N 21/4788; H04N 21/2335; H04N 21/4398
USPC 725/9

(57) ABSTRACT

In a viewing system, each of a plurality of mobile terminals includes a display unit, a program reception unit receiving a program of one-segment broadcasting, a display control unit causing the display unit to display the program received in the program reception unit, a microphone detecting the voice of a speaker around its own terminal while the program is being displayed on the display screen, a voice recognition unit converting the voice of the speaker detected by the microphone into character data, and a character data transmission and reception unit transmitting the character data converted in the voice recognition unit to a server and receiving character data, that is transmitted from another mobile terminal to the server, from the server, and the display control unit causes the display screen to display the character data received from the server with the program while the program is displayed on the display screen.

### FIELD OF THE INVENTION

The present invention relates to a viewing system, a mobile terminal, a server, and a viewing method by which a program of one-segment broadcasting can be viewed.

### DESCRIPTION OF THE RELATED ART

In most mobile terminals that are currently available, a one-segment function by which a program of only one-segment broadcasting can be viewed is provided.

However, the one-segment function of mobile terminals that are currently available is not suitable for a plurality of viewers to view a program together because the one-segment function is suitable for one user to view the program.

Recently, FIFA World Cup has been in full gear all over the world, and it is believed that many people have been viewing a program on a mobile phone by the one-segment broadcasting during work, etc.

In addition, among users who prefer to view a sports game or the like in a crowd in a public viewing area or the like, many want to view a game together and share the excitement instead of viewing the game alone.

Therefore, there have been proposed some technologies that allow the user to conveniently (virtually) share the empathy for the contents of a program with another user when the user is forced to view the program on his/her mobile device because the user has something to do.

For example, in Patent literature 1, a technology is disclosed in which, in a mobile terminal, chat messages that are transmitted and received between users are displayed with the program on a display screen of a program that is currently being viewed.

### LITERATURE OF THE PRIOR ART

### Patent Literatures

Patent literature 1: JP2006-129196

### SUMMARY OF THE INVENTION

### Problem to be Solved by the Invention

However, in a mobile terminal discussed in Patent literature 1, there is a problem in which it is necessary that a user inputs the characters of a chat message to the mobile terminal.

An object of the invention is to provide a viewing system, a mobile terminal, a server, and a viewing method by which the user conveniently (virtually) shares the empathy for the contents of a program with another user without inputting characters to the mobile terminal by the user.

### Means for Solving the Problem

A viewing system according to the invention includes a plurality of mobile terminals and a server. Each of the plurality of mobile terminals includes a display unit, a program reception unit that receives a program of one-segment broadcasting, a display control unit that causes a display screen of the display unit to display the program received in the program reception unit, a microphone that picks up the voice of a speaker around its own terminal while the program is being displayed on the display screen, a voice recognition unit that converts the voice of the speaker picked up by the microphone into character data, and a character data transmission and reception unit that transmits the character data converted in the voice recognition unit to the server and receives character data, that is transmitted from another mobile terminal to the server, from the server. The display control unit causes the display screen to display the character data received from the server with the program while the program is being displayed on the display screen.

A mobile terminal according to the invention includes a display unit, a program reception unit that receives a program of one-segment broadcasting, a display control unit that causes a display screen of the display unit to display the program received in the program reception unit, a microphone that picks up (sound of) voice of a speaker around its own terminal while the program is being displayed on the display screen, a voice recognition unit that converts the voice of the speaker picked up by the microphone into character data, and a character data transmission and reception unit that transmits the character data converted in the voice recognition unit to a server and receives character data, that is transmitted from another mobile terminal to the server, from the server. The display control unit causes the display screen to display the character data received from the server with the program while the program is being displayed on the display screen.

A server according to the invention includes a group management unit that manages mobile terminals that belong to a group for each group, and a character data distribution unit that receives character data, that is converted from the voice of a speaker around the mobile terminal while the program of one-segment broadcasting is being displayed on a display screen of the mobile terminal, from the mobile terminal, and distributes the character data to another mobile terminal that belongs to the same group as the mobile terminal.

A first viewing method of the invention is a viewing method performed by a mobile terminal, and the first viewing method includes receiving a program of one-segment broadcasting, displaying the received program on a display screen of a display unit, picking up the voice of a speaker around its own terminal while the program is being displayed on the display screen, converting the voice of the speaker picked up by the microphone to character data, transmitting the converted character data to a server and receiving character data, that is transmitted from another mobile terminal to the server, from the server, and displaying the character data received from the server with the program on the display screen while the program is being displayed on the display screen.

A second viewing method according to the invention is a viewing method performed by a server, and the second viewing method includes managing mobile terminals that belong to a group for each group, receiving character data, that is converted from the voice of a speaker around the mobile terminal while the program of one-segment broadcasting is being displayed on a display screen of the mobile terminal, from the mobile terminal, and distributing the character data to another mobile terminal that belongs to the same group as the mobile terminal.

### Effect of the Invention

The mobile terminal according to the invention converts the voice of the speaker picked up by the microphone into the character data and transmits the character data to the server during the viewing the program of the one-segment broadcasting while receiving character data, that is transmitted from another mobile terminal to server, from the server and displaying the received character data with the program on the display screen that is displaying the program.

Thus, an effect is obtained in which the user of the mobile terminal can conveniently (virtually) share the empathy for the contents of the program of the one-segment broadcasting with another user without inputting characters to the mobile terminal.

### BRIEF DESCRIPTION OF THE DRAWINGS

FIG. 1 is a diagram illustrating a configuration of a viewing system according to an exemplary embodiment;

FIG. 2 is a block diagram illustrating a configuration of a mobile terminal illustrated in FIG. 1:

FIG. 3 is a block diagram illustrating a configuration of an application server illustrated in FIG. 1;

FIG. 4 is a flowchart indicating an operation for creating a group in the application server illustrated in FIG. 1;

FIG. 5 is a flowchart indicating an operation for viewing a program in the application server illustrated in FIG. 1;

FIG. 6 is a flowchart indicating an operation for creating a group in the mobile terminal illustrated in FIG. 1;

FIG. 7 is a flowchart indicating an operation for viewing a program in the mobile terminal illustrated in FIG. 1;

FIG. 8 is a diagram illustrating an example of a display screen in the mobile terminal illustrated in FIG. 1; and

FIG. 9 is a diagram illustrating a state in which the mobile terminal illustrated in FIG. 1 is connected to an external television device.

### DETAILED DESCRIPTION OF THE PREFERRED EMBODIMENTS

The exemplary embodiments are described below with reference to accompanying drawings.

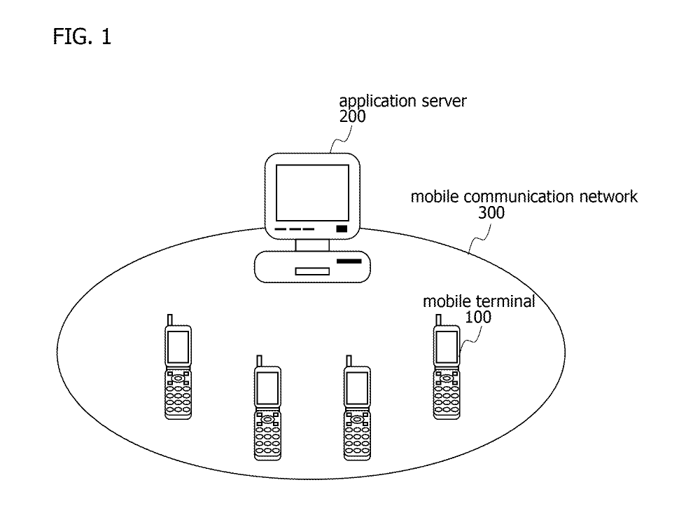

First, a configuration according to the present exemplary embodiment is described below with reference to FIGS. 1 to 3.

As illustrated in FIG. 1, the viewing system according to the present exemplary embodiment includes a plurality of mobile terminals 100 and application server 200. Each of mobile terminals 100 and application server 200 are connected to each other through mobile communication network 300.

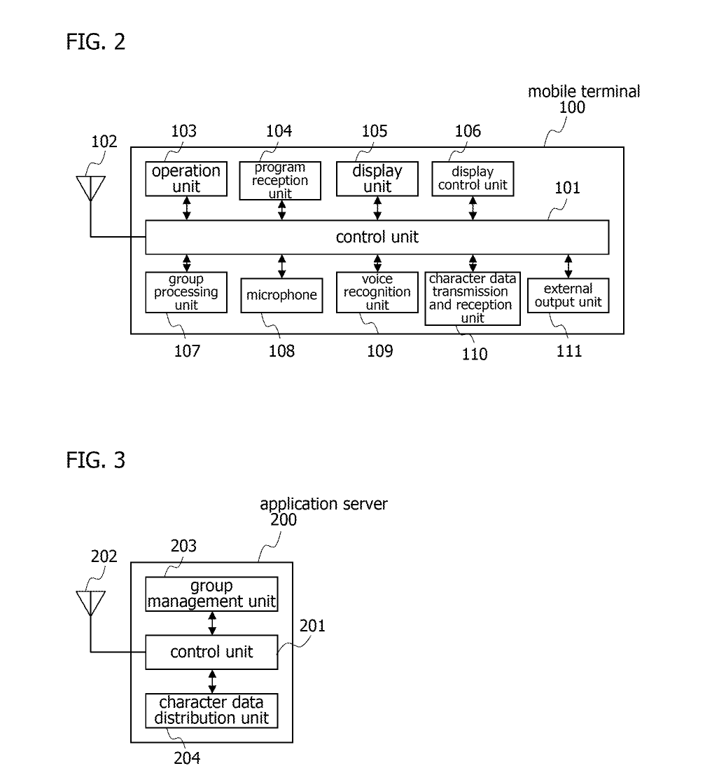

As illustrated in FIG. 2, mobile terminal 100 includes control unit 101, antenna 102, operation unit 103, program reception unit 104, display unit 105, display control unit 106, group processing unit 107, microphone 108, voice recognition unit 109, character data transmission and reception unit 110, and external output unit 111. FIG. 2 extracts and illustrates mere configuration elements that are related to the invention.

Control unit 101 controls the configuration elements in its own terminal and executes various processes.

Antenna 102 is an antenna that is used for transmitting and receiving various pieces of data by the configuration element in its own terminal.

In operation unit 103, various operations are performed by the user.

Program reception unit 104 receives a program of one-segment broadcasting.

Display unit 105 is a liquid crystal display (LCD), etc. that displays various pieces of data.

Display control unit 106 displays the program received in program reception unit 104 on a display screen of display unit 105.

Group processing unit 104 obtains a group ID of a group to which its own terminal belongs and a password beforehand.

For example, in a case in which its own terminal is a parent terminal (mobile terminal of a group creator), group processing unit 104 transmits a group creation request including identification information (telephone number, etc.) of mobile terminal 100, that wants to belong to the group, to application server 200, and obtains the group ID and the password transmitted from application server 200 as a response to the group creation request. In addition, group processing unit 104 transmits the obtained group ID and the password to another mobile terminal that belongs to the group.

On the other hand, in a case in which its own terminal is not a parent terminal, a group ID and a password are transmitted from the parent terminal as described above, and group processing unit 104 obtains the group ID and password.

In addition, group processing unit 104 transmits a group viewing request including identification information, a group ID, and a password of its own terminal to application server 200 in the viewing the program, and is connected to application server 200.

Microphone 108 picks up the voice of a speaker around its own terminal while the program is being displayed on the display screen.

Voice recognition unit 109 recognizes the voice of the speaker picked up by microphone 108 and converts the recognized voice into character data.

Character data transmission and reception unit 110 transmits the character data converted in voice recognition unit 109 to application server 200. In addition, character data transmission and reception unit 110 receives character data transmitted from another mobile terminal 100 to application server 200, from application server 200.

Display control unit 106 displays the character data received from application server 200 with the program on the display screen while the program is being displayed on the display screen.

External output unit 111 outputs screen data of the display screen to an external device.

As illustrated in FIG. 3, application server 200 includes control unit 201, antenna 202, group management unit 203, and character data distribution unit 204. FIG. 3 extracts mere configuration elements that are related to the invention and illustrates the configuration elements.

Control unit 201 controls the configuration elements in its own server and executes various processes.

Antenna 202 is an antenna that is used for transmitting and receiving various pieces of data by the configuration element in its own server.

When a group creation request is received from mobile terminal 100, group management unit 203 issues and transmits a group ID and a password to mobile terminal 100, and registers and manages the identification information, the group ID, and the password of mobile terminal 100 that belongs to the group, for the group. The management is performed for each of the groups.

In addition, when group management unit 203 receives a group viewing request from mobile terminal 100, group management unit 203 checks the identification information, the group ID, and the password that are registered beforehand against identification information, a group ID, and a password that are included in the group viewing request, and connects above-described mobile terminal 100 to its own server if there is no problem.

When character data distribution unit 204 receives character data from mobile terminal 100. character data distribution unit 204 distributes the character data to another mobile terminal 100 that belongs to the same group as above-described mobile terminal 100.

Operations of the present exemplary embodiment are described below.
(1) An Operation of Application Server 200
(1-1) An Operation for Creating a Group

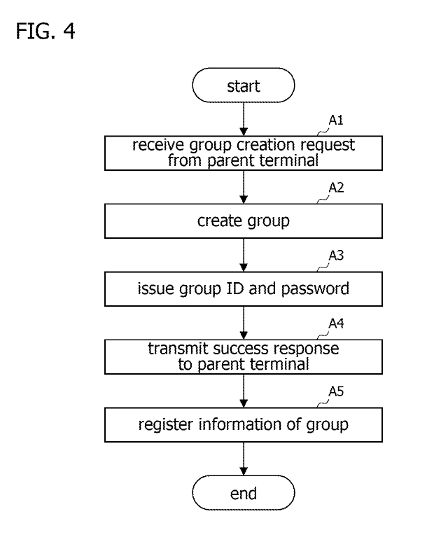

First, an operation in which mobile terminal 100 creates a group is described below with reference to the flowchart of FIG. 4.

As illustrated in FIG. 4, first, a group creation request including identification information (telephone number, etc.) of mobile terminal 100 that wants to belong to a group is received from the parent terminal (mobile terminal of the group creator) of mobile terminals 100 (Step A1).

Thereafter, group management unit 203 creates a group to which mobile terminal 100 the identification information of which is included in the group creation request belongs (Step A2).

Thereafter, group management unit 203 issues a group ID and a password of the above-created group (Step A3), and transmits a success response including the issued group ID and password to the parent terminal (Step A4).

Thereafter, for the group created as described above, group management unit 203 registers the identification information, the group ID, and the password of mobile terminal 100 that belongs to the created group (Step A5).
(1-2) An Operation for Viewing the Program

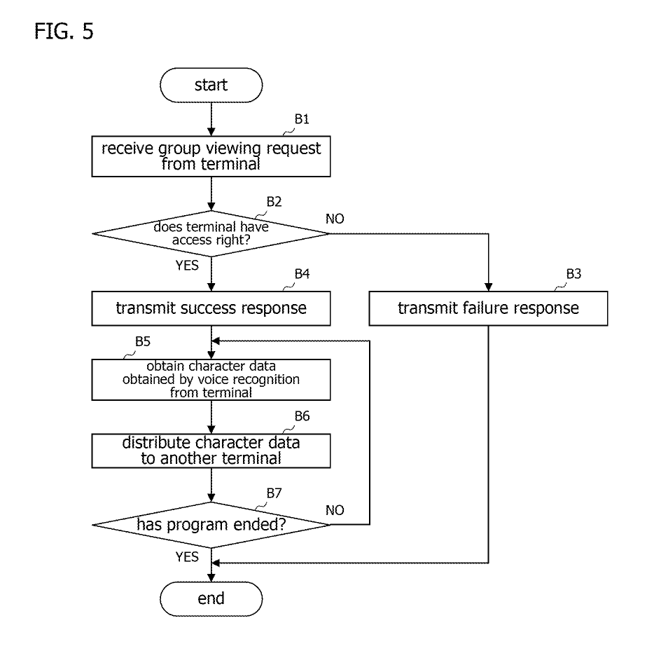

Next, an operation in which the program of the one-segment broadcasting is viewed in mobile terminal 100 is described below with reference to the flowchart of FIG. 5.

As illustrated in FIG. 5, first, a group viewing request including identification information (telephone number, etc.), a group ID, and a password is received from mobile terminal 100 (Step B1).

Thereafter, first, group management unit 203 checks the identification information included in the received group viewing request against identification information that has been registered beforehand, determines a group to which mobile terminal 100 belongs, checks the group ID and the password included in the received group viewing request against a group ID and a password that have been registered beforehand, and determines whether or not mobile terminal 100 has an access right (Step B2).

When mobile terminal 100 does not have an access right (NO in Step B2), group management unit 203 performs error processing in which a failure response is transmitted to mobile terminal 100 (Step B3), the process ends.

On the other hand, when mobile terminal 100 has an access right (YES in Step B2), group management unit 203 transmits a success response to mobile terminal 100, and mobile terminal 100 is connected to its own server (Step B4). When mobile terminal 100 succeeds in being connected to its own server, character data distribution unit 204 prepares obtaining processing and distribution processing of character data.

Upon completion of the preparation, the program of the one-segment broadcasting is started to be viewed in mobile terminal 100, character data distribution unit 204 obtains character data obtained by voice recognition (Step B5) because the character data is transmitted from mobile terminal 100 at any time.

In addition, character data distribution unit 204 distributes the character data obtained from mobile terminal 100 to another mobile terminal 100 that belongs to the same group as above-described mobile terminal 100 and is currently connected to its own server (Step B6).

Thereafter, character data distribution unit 204 repeatedly performs obtaining processing and the distribution processing of character data until the program ends (YES in Step B7), and the process ends when the program ends because a termination request is received from mobile terminal 100.
(2) An Operation of Mobile Terminal 100
(2-1) An Operation for Creating a Group

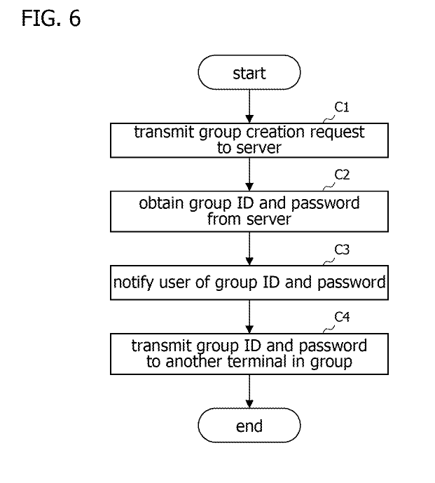

First, an operation for creating a group is described below with reference to the flowchart of FIG. 6. FIG. 6 illustrates an operation when mobile terminal 100 is a parent terminal (mobile terminal of a group creator).

As illustrated in FIG. 6, first, identification information (telephone number, etc.) of mobile terminal 100 that wants to belong to a group is input to operation unit 103 by the user, and group processing unit 104 transmits a group creation request, including the identification information input to operation unit 103, to application server 200 (Step C1).

When succeeding in creating the group, group processing unit 104 obtains a success response including a group ID and a password (Step C2) because the success response including the group ID and the password is transmitted from application server 200.

Next, group processing unit 104 notifies the user of the above-obtained group ID and password so as to display the above-obtained group ID and password on the display screen of display unit 105, etc. (Step C3).

Thereafter, group processing unit 104 transmits the above-obtained group ID and password to another mobile terminal 100 that belongs to the same group as above-described mobile terminal 100 (Step C4).

On the other hand, mobile terminal 100 that is not a parent terminal obtains a group ID and a password because the group ID and the password are transmitted from the parent terminal as described above.
(2-2) An Operation in the Viewing a Program

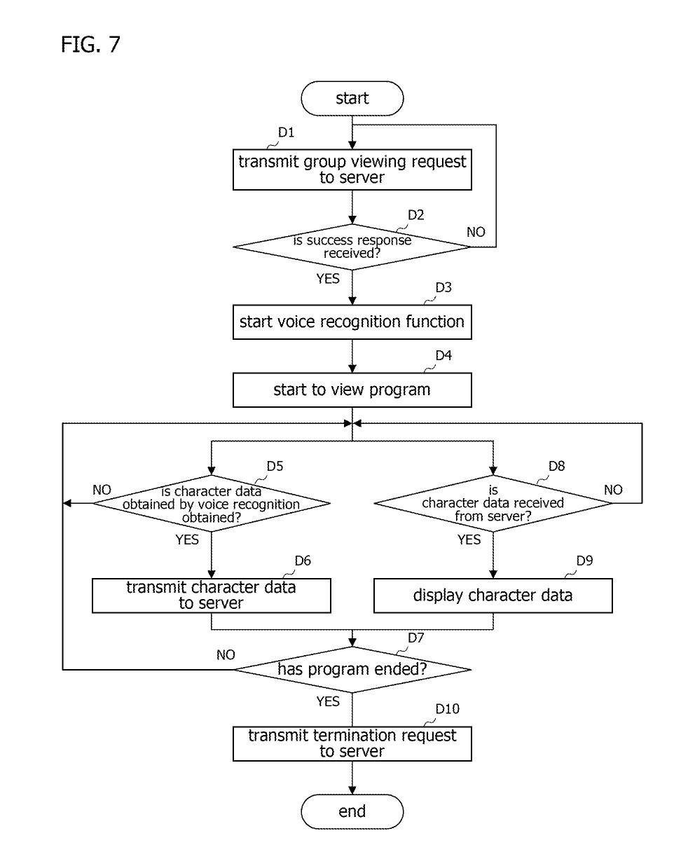

Next, an operation in which the program of the one-segment broadcasting is viewed is described below with reference to the flowchart of FIG. 7.

As illustrated in FIG. 7, first, a group ID and a password notified beforehand are input to operation unit 103 by the user, and group processing unit 104 transmits a group viewing request, including identification information (telephone number, etc.) of its own terminal, and the group ID and password that are input to operation unit 103, to application server 200 (Step Di).

The reception of a success response from application server 200 (Step D2) indicates that the connection to application server 200 has been completed, and control unit 101 starts functions (microphone 108, voice recognition unit 109, and character data transmission and reception unit 110) related to voice recognition of its own terminal to prepare automatic transmission of the voice of the speaker around its own terminal to application server 200 as character data (Step D3).

When the program of the one-segment broadcasting is started to be viewed in mobile terminal 100 (Step D4), microphone 108 picks up the voice of the speaker around its own terminal, and voice recognition unit 109 recognizes the voice of the speaker and converts the recognized voice into character data.

When character data transmission and reception unit 110 obtains the character data obtained by voice recognition in voice recognition unit 109 (YES in Step D5), the obtained character data is transmitted to application server 200 (Step D6). Thereafter, processing to obtain and processing to transmit character data obtained by voice recognition are repeatedly performed until the program ends (YES in Step D7).

In addition, while repeating processing to obtain and processing to transmit character data, character data transmission and reception unit 110 receives the character data (YES in Step D8) because the character data transmitted from another mobile terminal 100 to application server 200 is transmitted from application server 200, and display control unit 106 displays the character data received from application server 200 on the display screen on which the program is being displayed (Step D9). Newly received character data is displayed so as to be overwritten on the display screen because character data is received at any time. Thereafter, until the program ends (YES in Step D7), processing to receive and processing to display character data are repeated.

When the program ends, group processing unit 104 transmits a termination request to application server 200 (Step D10), and the process ends.

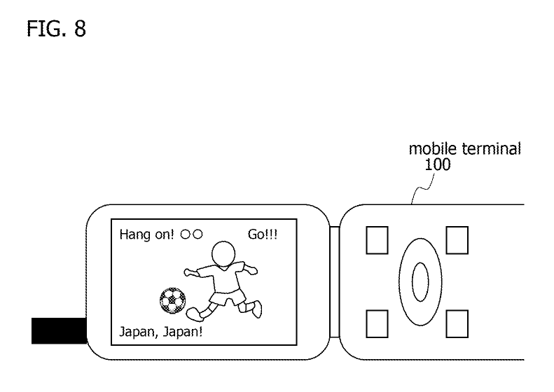

FIG. 8 illustrates an example of the display screen in Step D9.

In the example of FIG. 8, in the display screen on which a soccer game is displayed, character data of voice such as “Hang on! OO”, “Go!!!”, and “Japan, Japan!” recognized in another mobile terminal 100 that belongs to the same group as its own terminal is displayed with the program.

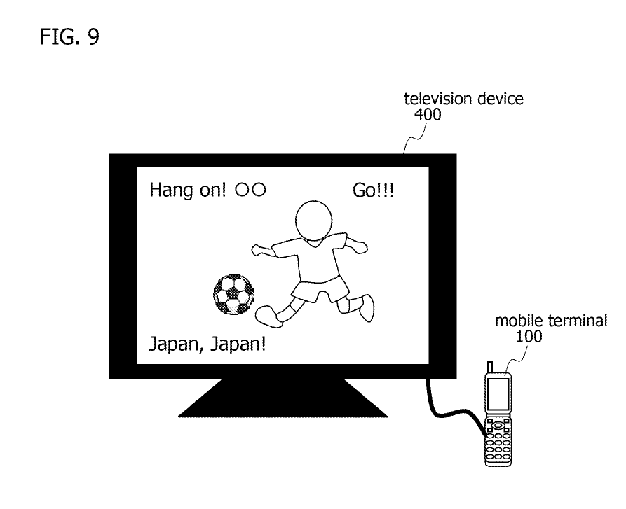

In addition, in mobile terminal 100, for the user who finds it difficult to view the program on the display screen because the display screen is small, as illustrated in FIG. 9, external output unit 111 of mobile terminal 100 is connected to external television device 400 through a high-definition multimedia interface (HDMI), etc., and screen data of the display screen illustrated in FIG. 8 is output to television device 400 to display the screen data on the screen of television device 400.

As described above, in the present exemplary embodiment, mobile terminal 100 converts the voice of the speaker picked up by microphone into character data and transmits the character data to application server 200 during the viewing the program of the one-segment broadcasting. At the same time, mobile terminal 100 receives character data transmitted from another mobile terminal 100 to application server 200, from application server 200, and displays the received character data with the program on the display screen that is currently displaying the program.

Thus, an effect is obtained in which the user of mobile terminal 100 can conveniently (virtually) share the empathy for the contents of the program of the one-segment broadcasting with another user without inputting characters to the mobile terminal by the user.

In addition, in the present exemplary embodiment, application server 200 manages mobile terminals 100 that belong to a group and distributes, when receiving the character data from mobile terminal 100, character data to another mobile terminal 100 that belongs to the same group as above-described mobile terminal 100.

Thus, an effect is obtained in which the user of mobile terminal 100 can share the empathy for the contents of the program of the one-segment broadcasting only among the friends.

In addition, in the present exemplary embodiment, an effect is obtained in which the user of mobile terminal 100 can view the display screen on a large screen by outputting screen data of the display screen to an external television device, etc., in mobile terminal 100.

In addition, in the present exemplary embodiment, an effect is obtained in which the user of mobile terminal 100 can share the empathy for the contents of the program with another user without being connected to the Internet, etc. because mobile terminal 100 and application server 200 are connected to each other through mobile communication network 300.

### EXPLANATION OF REFERENCE NUMERALS

100 mobile terminal

101 control unit

102 antenna

103 operation unit

104 program reception unit

105 display unit

106 display control unit

107 group processing unit

108 microphone

109 voice recognition unit

110 character data transmission and reception unit

111 external output unit

200 application server

201 control unit

202 antenna

203 group management unit

204 character data distribution unit

300 mobile communication network

400 television device

1. A viewing system comprising:
a plurality of mobile terminals; and
a server, each of said plurality of mobile terminals including:
a display unit;
a program reception unit that receives a program of one-segment broadcasting;
a display control unit that causes a display screen of the display unit to display the program received in the program reception unit;
a microphone that picks up voice of a speaker around its own terminal while the program is being displayed on the display screen;
a voice recognition unit that converts the voice of the speaker picked up by the microphone into character data; and
a character data transmission and reception unit that transmits the character data converted in the voice recognition unit to said server and receives character data, that is transmitted from another mobile terminal to said server, from said server, wherein
the display control unit causes the display screen to display the character data received from said server with the program while the program is being displayed on the display screen.

2. The viewing system according to claim 1, wherein
said server includes a group management unit that manages said mobile terminals that belongs to a group for each group, and a character data distribution unit that distributes the character data to another mobile terminal that belongs to the same group as said mobile terminal when the character data distribution unit receives the character data from said mobile terminal.

3. The viewing system according to claim 1, wherein
each of said plurality of mobile terminals further includes an external output unit that outputs screen data of the display screen to an external device.

4. The viewing system according to claim 1, wherein
each of said plurality of mobile terminals and said server are connected to each other through a mobile communication network.

5. A mobile terminal comprising:
a display unit;
a program reception unit that receives a program of one-segment broadcasting;
a display control unit that displays the program received in said program reception unit on a display screen of said display unit;
a microphone that picks up voice of a speaker around its own terminal while the program is being displayed on the display screen,
a voice recognition unit that converts the voice of the speaker picked up by said microphone into character data, and
a character data transmission and reception unit that transmits the character data converted in said voice recognition unit to a server and receives character data, that is transmitted from another mobile terminal to the server, from the server, wherein
the display control unit causes the display screen to display the character data received from the server with the program while the program is being displayed on the display screen.

6. A server comprising:
a group management unit that manages mobile terminals that belong to a group for each group, and
a character data distribution unit that receives character data, that is converted from the voice of a speaker around the mobile terminal while the program of one-segment broadcasting is being displayed on a display screen of the mobile terminal, from the mobile terminal, and distributes the character data to another mobile terminal that belongs to the same group as the mobile terminal.

7. A viewing method that is performed by a mobile terminal, the viewing method comprising:
receiving a program of one-segment broadcasting;
displaying the received program on a display screen of a display unit;
picking up voice of a speaker around its own terminal while the program is being displayed on the display screen;
converting the voice of the speaker picked up by the microphone to character data;
transmitting the converted character data to a server and receiving character data, that is transmitted from another mobile terminal to the server, from the server; and
displaying the character data received from the server with the program on the display screen while the program is being displayed on the display screen.

8. A viewing method that is performed by a server, the viewing method comprising:
managing mobile terminals that belong to a group for each group; and
receiving character data, that is converted from the voice of a speaker around the mobile terminal while the program of one-segment broadcasting is being displayed on a display screen of the mobile terminal, from the mobile terminal, and distributing the character data to another mobile terminal that belongs to the same group as the mobile terminal.

9. The viewing system according to claim 2, wherein
each of said plurality of mobile terminals further includes an external output unit that outputs screen data of the display screen to an external device.

10. The viewing system according to claim 2, wherein
each of said plurality of mobile terminals and said server are connected to each other through a mobile communication network.

11. The viewing system according to claim 3, wherein
each of said plurality of mobile terminals and said server are connected to each other through a mobile communication network.

12. The viewing system according to claim 9, wherein
each of said plurality of mobile terminals and said server are connected to each other through a mobile communication network.
